(19) United States
(12) Patent Application Publication
(10) Pub. No.: US 2015/0281340 A1
(43) Pub. Date: Oct. 1, 2015

(54) DATA COMMUNICATIONS METHOD AND SYSTEM

(71) Applicant: HIGHGATE LABS LIMITED, London (GB)

(72) Inventor: Edward Lea, London (GB)

(21) Appl. No.: 14/417,426

(22) PCT Filed: Jul. 26, 2013
(86) PCT No.: PCT/GB2013/052023

§ 371 Date: Jan. 26, 2015

Related U.S. Application Data
(60) Provisional application No. 61/676,017, filed on Jul. 26, 2012.

(30) Foreign Application Priority Data
Jul. 26, 2012 (GB) 1213281.7

(51) Int. Cl. H04L 29/08; H04L 29/06

(52) U.S. Cl. CPC H04L 67/1002; H04L 67/02; H04L 67/42

(57) ABSTRACT

The present invention relates to a data communications method. The method coordinates data communication between a first and second user device in a system including a first and second server, by the second server generating a unique identifier and transmitting the identifier and a resource location for receipt by the first user device via the first server; the first user device requesting a resource at the resource location; the second server transmitting the resource including a second executable component to the first user device; the first user device executing the second component to create a connection (such as a two-way socket) between the first user device and the second server; the second user device receiving the identifier; the second user device using the identifier to claim the connection to the first user device from the second server; and the second server coordinating data communication between the first and second user device. A data communication system, and a server and user devices for use with the system are also disclosed.

### FIELD OF INVENTION

The present invention is in the field of communications. More particularly, but not exclusively, the present invention relates to a two-way real-time Internet communications protocol.

### BACKGROUND

Instant messaging systems, such as Skype™ and Facebook™ Chat, provide various types of real-time communication between different clients, marshalled by a central server.

For example, in relation to the Skype™ system, two users on different devices and networks can communicate in real-time. The connection between the two parties is established by both communicating with one of several central Skype™ servers. Each client sets up a connection and provides enough information such that the servers have sufficient information to allow the clients to communicate directly. The Skype™ servers, to which the clients have connected, exchange their connected client's details allowing them to communicate directly and removing the central servers from the “conversation”.

Facebook™ uses a more traditional system where each client connects to one of many Facebook™ chat servers. Messages are then sent in real-time from client to server to server to client.

In both cases described, the users interact directly with the Facebook™ and Skype™ servers to initiate communications.

It would be desirable if users could initiate communications through a third party server. For example, if the third party server is a merchant server and the communications mechanism is subsidiary to the products or services offered via the merchant server.

It would also be desirable if users could initiate the communications within a web-browser to provide for wider adoption.

It is an object of the present invention to provide a data communications method and system which meets the above desires and overcomes the disadvantages of the prior art, or at least provides a useful alternative.

### SUMMARY OF INVENTION

According to a first aspect of the invention there is provided a method for coordinating data communication between a first and second user device in a system including a first and second server, including:

a. the second server generating a unique identifier and transmitting the identifier and a resource location for receipt by the first user device via the first server;

b. the first user device requesting a resource at the resource location;

c. the second server transmitting the resource including a second executable component to the first user device;

d. the first user device executing the second component to create a connection between the first user device and the second server;

e. the second user device receiving the identifier;

f. the second user device using the identifier to claim the connection to the first user device from the second server; and

g. the second server coordinating data communication between the first and second user device.

According to another aspect of the invention there is provided a data communication system, including:

a first user device configured to receive an identifier and resource location from a second server via a first server, to request a resource at the resource location and to execute a second component to create a connection between the first user device and the second server;

a second user device configured to receive the identifier, and to use the identifier to claim the connection to the first user device from the second server;

a first server configured to transmit the resource location from the second server to the first user device; and

a second server configured to generate a unique identifier, to transmit the identifier and a resource location for receipt by the first user device via the first server, to transmit the resource including a second executable component to the first user device, and to coordinate data communication between the first and second user device.

According to another aspect of the invention there is provided a server for use in a data communication system, the server configured to generate a unique identifier, to transmit the identifier and a resource location for receipt by a first user device via another server, to transmit the resource including a second executable component to the first user device, and to coordinate data communication between the first user device and a second user device.

According to another aspect of the invention there is provided a user device for use in a data communication system, the user device configured to receive an identifier and a resource location from a second server, to request a resource at the resource location, to receive a resource including a second executable component and to execute the second component to create a connection between the user device and the second server.

According to another aspect of the invention there is provided a user device for use in a data communication system comprising a server and another user device, the user device configured to receive an identifier via the another user device, and to use the identifier to claim a connection to the first user device from the server.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a system in accordance with an embodiment of the invention;

FIG. 2: shows a method in accordance with an embodiment of the invention; and

FIG. 3: shows an implementation of a payment service using a communications mechanism in accordance with an embodiment of the invention.

### DETAILED DESCRIPTION OF PREFERRED EMBODIMENTS

The present invention provides a data communications method and system.

The invention may provide a mechanism to enable, at least, two client devices to communicate in real-time by both connecting to the same server.

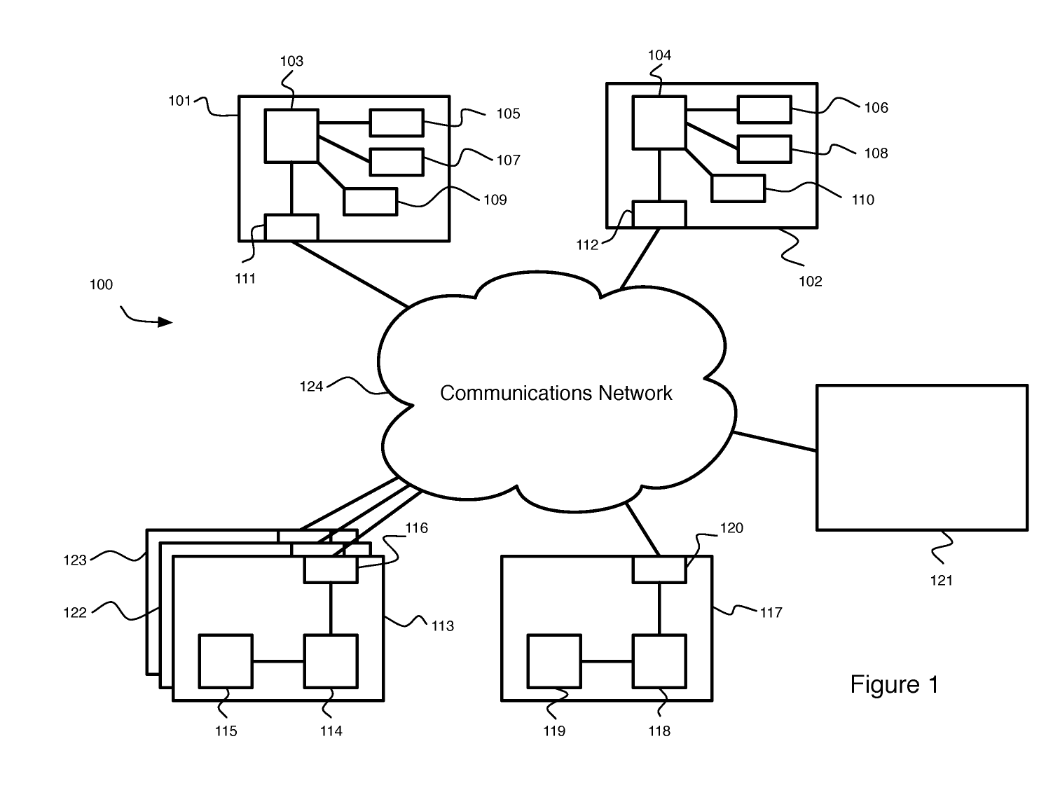

In FIG. 1, a data communications system 100 in accordance with an embodiment of the invention is shown.

The system 100 includes a first user device 101, such as a computing device (i.e. a computer or laptop), or a physical apparatus capable of interacting with a user, such as a point-of-sale terminal or ticket machine. A second user device 102, such as a mobile computing device (i.e. a smart-phone or tablet computer) is also shown.

Both user devices 101, 102 may include a processor 103, 104, a memory 105, 106, an input 107, 108, an output 109, 110, and a communications module 111, 112.

The system 100 also includes an application server 113. The application server 113 may include a processor 114, a memory 115, and a communications module 116. The system 100 may also include a gateway server 117. The gateway server 117 may include a processor 118, a memory 119, and a communications module 120.

A third party server 121 is also shown.

The gateway server 117 is configured to communicate with the third party server 121 and the first user device 101.

The system 100 may include a plurality of application servers 113, 122, 123. The gateway server 117 may be further configured to select an application server 113 from the plurality of application servers 113, 122, 123 based upon load and to route requests from third party servers 121 to the selected application server 113.

The second user device 102 is configured to communicate with the application server 113. The communication is via a communications network 124 such as mobile Internet.

The first user device 101 may be configured to receive a first executable component (such as a Javascript component) from the third party server 121 (the first user device 101 may receive from the third party server 121 a location for the first executable component which may be located at another server), to execute the first component to request an identifier via the third party server 121, to receive the identifier and a resource location (such as a URL) from the application server 113, to request a resource at the resource location (which may be located at the application server 113), to receive the resource (which comprises a second executable component), and to execute the second component to create a two-way socket between the first user device 101 and the application server 113. The two-way socket may initiate the creation of a communication connection. It will be appreciated that another communications protocol may be used in place of the two-way socket to establish a connection between the first user device 101 and the application server 113. Preferably the connection is persistent.

The resource request may also include the identifier.

The first user device 101 may be configured for outputting the identifier via the output 109. The output 109 may be a visual display.

The second user device 102 may be configured to receive the identifier (for example, from the output 109 of the first device 101), and to use the identifier to claim a communication connection to the first user device 101 from the application server 113.

In one embodiment, where the first user device 101 is configured for outputting the identifier via a visual display 109, the second user device 102 may receive the identifier via the input 108 which may be a visual capture device, such as a camera.

The third party server 121 may be configured to receive requests for identifiers from user devices 101, and to relay the requests for receipt by the application server 113.

The third party server 121 may be under the control of a merchant.

It will be appreciated that the system may include a plurality of third party servers 121, belonging to a plurality of merchants or third parties.

The application server 113 may be configured to generate a unique identifier, to transmit the identifier and a resource location for receipt by the first user device 101 via the third party server 121, to transmit the resource including a second executable component to the first user device 101, and to coordinate data communication between the first 101 and second user devices 102.

The application server 113 may be configured to flag the identifier used in the two-way socket connection to the first user device 101 as “in use” and to block future requests to establish a two-way socket using the flagged identifier.

The application server 113 may also be configured to flag identifiers claimed by second user device 102 as “claimed” and to block future requests to claim the identifier.

It will be appreciated that a combination gateway/application server may perform the functions of both the application server 113 and gateway server 117.

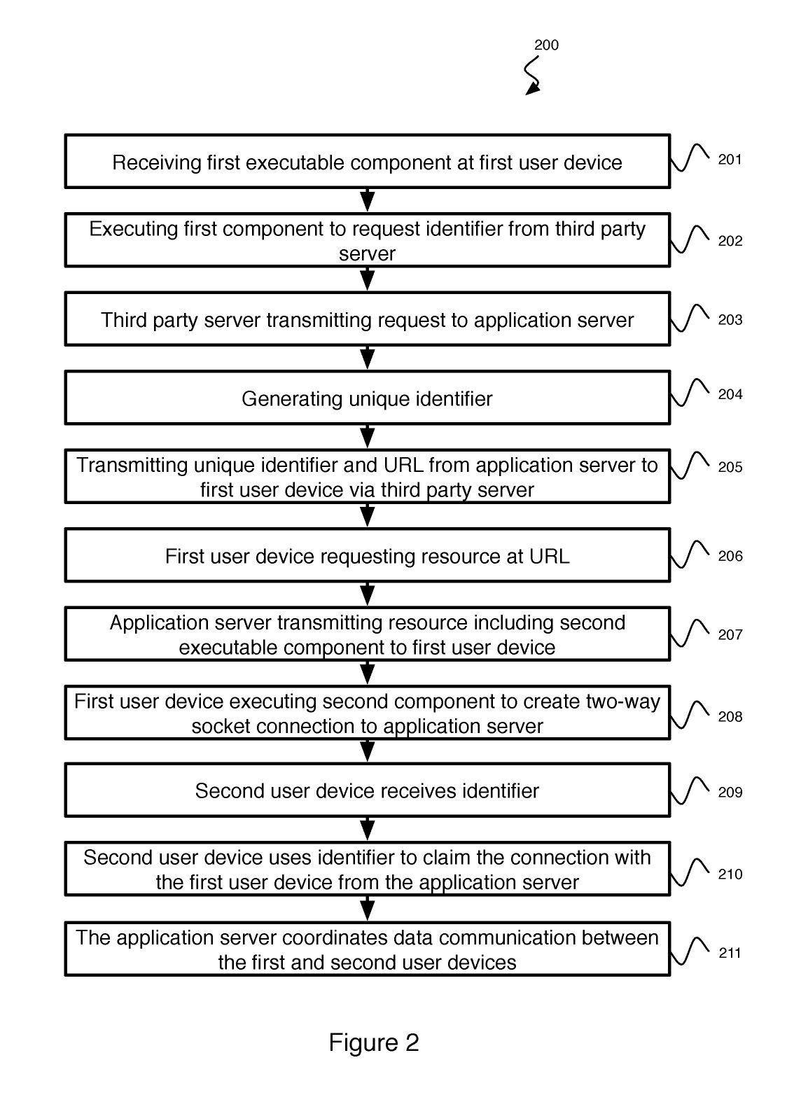

In FIG. 2, a method 200 in accordance with an embodiment of the invention is shown.

The user may access a website at the third party server using the first user device.

The website may include an executable component for download to the first user device in step 201. The executable component may be embedded within a requested webpage on the website. The executable component may comprise a Javascript library. In one embodiment, the executable component is a script within the HTML itself (such as Javascript) and, in another embodiment, the executable component is a separate file such as a “.js” Javascript file and is embedded within the webpage as an URL to the file on a server.

The first user device may execute the executable component in step 202. The component may, when executed, request an identifier from the third party server. The third party server may receive the request and forward it to an application server in step 203. The gateway server may select and deliver the request to an application server selected from a plurality of application servers. The gateway server may utilise load-balancing techniques to select the application server.

The application server may generate, in step 204, a unique identifier for the session (or transaction). The application server may deliver the identifier and a resource location (such as a URL) identifying the server back to the first user device in step 205. This delivery may be coordinated through the third party server.

In an alternative embodiment, the first user device may not receive the first executable component and may not explicitly request the identifier, but the third party server may request the identifier. The third party server can then deliver the identifier and the resource location from the application server to the first user device within, for example, a web-page.

The first user device receives the identifier and URL, and the executable component, during execution, may make a request (i.e. a HTTP/HTTPS request) of the application server using the URL in step 206. The request may include the identifier.

The application server may generate and return a resource to the first user device corresponding to the URL (i.e. a webpage) comprising a second executable component in step 207. The second executable component may be Javascript embedded within a webpage. As above, the second executable component may be Javascript within the HTML of the webpage or may be downloaded via a URL to a Javascript file stored on a server. The resource may also include the identifier. The identifier may be encoded, for example, within an image as a QR (Quick Response) code. Other graphically encoded systems can be envisaged, such as 2D barcodes. Usefully an image can be detected by a camera at a second user device. The encoded identifier may also include an address for the application server.

The first user device may execute the second executable component in step 208, and the second executable component may, when executed, create a two-way socket connection using the identifier with the application server.

The second executable component may be executed by a web-browser. The second executable component may be executed within an overlay to the webpage requested from the third party server.

When the application server connects via the two-way socket connection with the first user device, the application server may map the socket to the identifier and flag the identifier as “in use”. The application server may deny future attempts by devices to create a two-way socket connection with the application server using the same identifier.

The second user device may receive the identifier (or encoded identifier) in step 209. The second user device may receive the identifier, for example, from the first user device by visually capturing the QR code displayed on the first user device. If the identifier is encoded, the second user device may decode it.

The second user device may contact the application server and transmit the identifier in step 210. The second user device may also obtain the address for the application server, for example, from the first user device via the QR code.

When the application server receives the transmitted identifier from the second user device, the application server may flag the identifier as claimed, and deny future attempts to “claim” the identifier by other devices.

The application server may coordinate data communications between the two devices in step 211. For example, the application server may transmit first data to the first user device and second related data to the second user device.

The same user may be using both user devices, and the data communications may relate to a transaction, such as an attempt by the user to purchase goods or services from the third party server. In this case, the application server may coordinate communications by receiving user input and/or stored data from the second user device, and to then update the progress of the transaction on the first user device.

Communication to and from the application server to the first user device may be via the two-way socket.

Communication to and from the second user device may be via a long polling request. In this case, the second user device may make a long polling request (for example, a long polling HTTP request) of the application server to enable the server to later transmit information to the second user device. For example, where the user is using the first user device to initiate a transaction, the second user device may be notified of confirmation as a response to the long polling request.

In an alternative embodiment, push messaging may be used to communicate between the application server and the second user device.

It will be appreciated that in other embodiments, the application server may use different communications channels to communicate with the second user device.

When the session is completed (for example, for a transaction, when the transaction has been confirmed or has been abandoned by the user) the first executable component executing on the first user device may ends its own execution, for example, by initiating a reload within the web-browser.

In an alternative embodiment, when the session is completed the first executable component executing on the first user device may make a request to the third party server for a closing webpage. The closing webpage may include a third executable component, which when executed on the first user device ends execution of the first executable component.

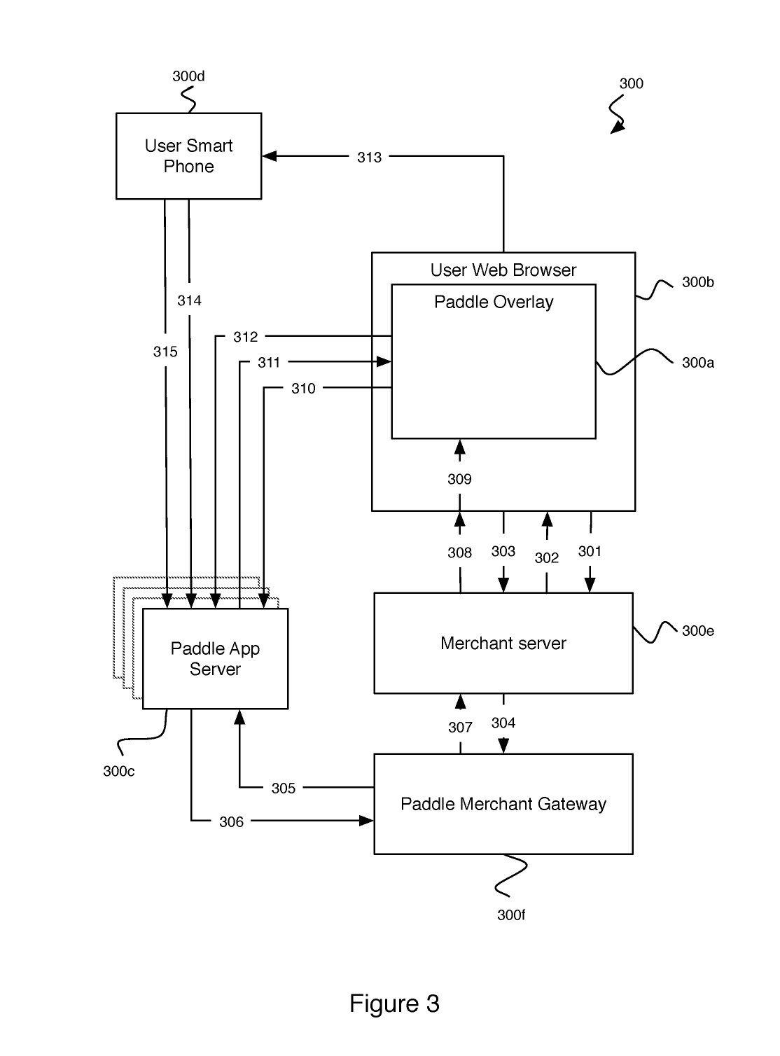

With reference to FIG. 3, a payment service utilising an exemplary data communications system 300 of an embodiment of the invention will be described.

The following data communications system 300 may enable all the different components of a payment service to communicate seamlessly and reliably. This may be achieved, in this example, by using a custom load-balancing approach along with a combination of long-lived HTTP sessions and socket connections.

In this embodiment, the data communications system 300 will be referred to as Paddle.

The data communications system 300 includes a first executable component called the Paddle client library. The library may be used to create an overlay 300a within a web browser on a user device 300b to manage communications at the user device 300b. The Paddle client library may be a Javascript library.

The system 300 also includes a second executable component for creating a two-way socket connection between the user device 300b and a Paddle application server 300c.

The user also has a smart-phone 300d. An app (mobile application) may be executing on the user's smart-phone 300d.

In this payment service, the user at the user device 300b interacts with a merchant third party server 300e to pay for a good or service. The merchant third party server 300e uses a Paddle merchant gateway 300f to interface with the Paddle application server 300c.

The Paddle application server 300c establishes a communications channel in order to coordinate payment details and confirmation between the user device 300b and the user's smart-phone 300d. The payment service may utilise multiple user devices where a more secure or more efficient payment mechanism is desired or required.

In step 301, the user's web browser 300b makes a HTTP/HTTPS request for a webpage from the merchant server 300e.

In step 302, the webpage, including the Paddle client JavaScript library is returned.

The webpage is displayed within the browser 300b. The webpage includes a button labelled “Pay with Paddle” provided by the Paddle client Javascript library. The user clicks the “Pay with Paddle” button, which triggers the library to make an AJAX/XHR request, in step 303, back to the merchant server 300e.

In step 304, the merchant server 300e then makes an HTTP/HTTPS request to a pre-assigned merchant gateway 300f. Each merchant is assigned a single server DNS name representing the pre-assigned merchant gateway 300f; the redundancy and availability of this service is managed at the network layer using either a conventional load-balancer or similar.

The merchant gateway 300f uses historical information in a load balancing system to allocate a Paddle application server 300c from a pool of available application servers. Specifically, the merchant gateway 300f periodically checks the load on each server 300c to ensure requests are balanced within the pool of application servers 300c. Transaction details are sent to the selected application server via local (i.e. not publicly routable) network interface in step 305.

The application server 300c creates a unique identifier for this transaction that is returned, in step 306, to the merchant gateway 300f along with the application server's publicly resolvable hostname; the application server 300c can also reject this request (i.e. based upon current load), in which case the merchant gateway 300f selects the next best option from the application server pool and repeats step 305.

In step 307, the hostname and transaction ID are returned by the merchant gateway 300f to the merchant server 300e.

In step 308, the hostname and transaction ID are returned by the merchant server 300e to the user's web browser 300b (as the return data for the request made in step 303).

In step 309, the Paddle client JavaScript library creates an iframe overlay (the Paddle Overlay 300a) with the Paddle application server URL, including the transaction ID as a parameter to the URL, as the iframe's source. For example, https://server-123.paddle.to/?transaction ID=we9sdf80987dcz.

In step 310, the iframe requests the page corresponding to the URL from the Paddle application server 300c.

In step 311, the page is returned, including the transaction identifier encoded in a QR code.

The returned page also includes the second executable component, which may be JavaScript. Execution of the Javascript opens a two-way socket, in step 312, to allow for communication from the application server 300c to the Paddle overlay 300a. Once the socket is open, the transaction ID is flagged by the application server so that step 312 would fail for subsequent requests with the same transaction ID; i.e. the URL can only be opened once. The application server 300c holds an in-memory map of the socket to the transaction ID.

In step 313, the user's smart-phone app 300d may scan the QR code and decode it to retrieve, the Paddle application server hostname and the transaction ID.

In step 314, the smart-phone app 300d makes a signed request to the application server 300c to “claim” this transaction using the transaction ID; again the transaction ID is flagged so that no other app can “claim” it.

In step 315, a long polling HTTP connection is also opened by the app to the Paddle application server 300c. This request will only return when the transaction completes or if the user cancels the transaction in the browser 300b. The application server 300c holds an in-memory map of the long polling HTTP connection to the transaction ID.

If the user cancels the payment from within the Paddle Overlay 300a, or when the payment has completed, the Paddle Overlay 300a communicates with the application server 300c via the two-way socket to relay the payment instructions and then instructs the browser 300b to reload the page hosting it, effectively dismissing the Paddle Overlay 300a.

If the user cancels or confirms the payment within the app on the smart-phone 300d, the application server 300c communicates the cancellation or confirmation to the Paddle Overlay 300a via the two-way socket. The Paddle Overlay 300a then instructs the browser 300b to reload the page hosting it, effectively dismissing the Paddle Overlay 300a.

Using the connections opened in steps 312 and 315, the smart-phone 300d app, Paddle application server 300c and Paddle Overlay 300a in the user's web browser 300b are able to communicate asynchronously, with the user interface of each updating as the user progresses through the payment process. It also allows for other peripheral functions to be performed—for example, the smart-phone 300d app can instruct the Paddle Overlay 300a to display a form to enter the details of a new payment card. Because the Paddle application server 300c marshals the connections between the overlay 300a and smart-phone 300d app, it knows that data sent back from the form is intended for the identity presented by the smart-phone 300d.

The data communications system provides for communications between user devices to be initiated by a third party server, but then for the third party server to be permitted controlled access to communications to and from the user devices. Therefore, the communications channel has the flexibility of being able to be created at a potentially unsecure server.

The data communications system has particular application for payment services where the customer does not entirely trust the merchant or where the merchant wishes to ensure security of payment for the customer.

In this application, payment details of a customer can be stored by the application server and can be used directly with the merchant's payment acquirer.

There are a number of payment acquirers that have different APIs. A merchant typically transacts with a single payment acquirer and integrates their payment systems with the acquirer's system via the acquirer's API.

To authenticate themselves with a payment acquirer the merchant is granted credentials by the payment acquirer which are used within the API.

Each payment acquirer API requires similar sets of data for arranging payment (credit card number, CV2, expiry date, billing address, etc).

However, each payment acquirer may utilise different implementations. For example, some APIs may utilise XML while others use JSON to communicate the required data.

In one embodiment of the invention, the application server stores the merchant's credentials for their payment acquirer, and stores the entire set of data for each customer that could be required for payment. The application server can also be configured which plug-ins to interface with a plurality of acquirer's APIs.

The data communications system, in that embodiment, will now facilitate payment by customers for merchants without changing the merchant's payments processes because the same payment acquirer is being used, without any integration overhead at the merchant side, and the merchant can use the same systems provided by the payment acquirer for cancelling transactions or for reporting, etc.

Plug-ins for new payment acquirers can be easily built and deployed to the application server when necessary.

It will be appreciated by those skilled in the art that embodiments of the invention described above may be implemented within hardware components, within software components, or as a mixture of both hardware and software components. It will be appreciated that the software components may be stored within a medium.

Potential advantages of some embodiments of the present invention are that the third party server can be used to initiate communication but can be isolated from the communication for security reasons; the third party server can manage closing of the communication; load balancing can be improved because a new second executable component is transmitted for each connection; and browser security is maintained.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for coordinating data communication between a first and second user device in a system including a first and second server, including:
a. the second server generating a unique identifier and transmitting the identifier and a resource location for receipt by the first user device via the first server;
b. the first user device requesting a resource at the resource location;
c. the second server transmitting the resource including a second executable component to the first user device;
d. the first user device executing the second component to create a connection between the first user device and the second server;
e. the second user device receiving the identifier;
f. the second user device using the identifier to claim the connection to the first user device from the second server; and
g. the second server coordinating data communication between the first and second user device.

2. A method as claimed in claim 1, further including the steps of:
the first user device receiving a first executable component;
the first user device executing the first component to request the identifier via the first server; and
the first server transmitting the request for receipt by a second server;
wherein the second server generates and transmits the identifier and resource location in response to the request.

3. A method as claimed in claim 2, wherein the first user device requests the first executable component using a location provided by the first server.

4. A method as claimed in claim 1, wherein the identifier and the resource location are received from the first server within a web-page.

5. A method as claimed in claim 1, herein the connection is a two-way socket connection.

6. A method as claimed in claim 1, including the step of the first user device executing the first component to close the connection.

7. A method as claimed in claim 1, wherein the second server maps the identifier to the connection.

8. A method as claimed in claim 1, wherein the resource request includes the identifier.

9. A method as claimed in claim 8, wherein the second server flags the identifier as in use when the request is received.

10. A method as claimed in claim 9, wherein the second server denies requests when the identifier is flagged as in use.

11. A method as claimed in claim 1, wherein the second server flags the identifier as claimed when the second user device claims the connection using the identifier.

12. A method as claimed in claim 11, wherein the second server denies attempts to claim the connection when the identifier is flagged as claimed.

13. A method as claimed in claim 1, wherein the executable components are executed within a web-browser.

14. A method as claimed in claim 1, wherein a gateway server receives the request from the first server and selects the second server from a plurality of servers.

15. A method as claimed in claim 14, wherein the gateway server selects the second server based upon load-balancing.

16. A method as claimed in claim 1, wherein the second server transmits the identifier and resource location to the first server via the gateway.

17. A method as claimed in claim 1, wherein the resource is a web-page.

18. A method as claimed in claim 1, wherein the second user device generates a long-polling request of the second server.

19. A method as claimed in claim 18, wherein the second server communicates data relating to the first user device in response to the long-polling request.

20. A method as claimed in claim 1, wherein the first user device requests the resource for display in an overlay for a web-page received from the first server within a web-browser.

21. A method as claimed in claim 20, wherein the second executable component executes within the overlay.

22. A method as claimed in claim 1, wherein the second user device receives the identifier via the first user device.

23. A method as claimed in claim 22, wherein the second user device receives the identifier from the first user device by capturing via a camera an image encoding the identifier displayed on the first user device.

24. A data communication system, including:
a first user device configured to receive an identifier and resource location from a second server via a first server, to request a resource at the resource location and to execute a second component to create a connection between the first user device and the second server;
a second user device configured to receive the identifier, and to use the identifier to claim the connection to the first user device from the second server;
a first server configured to transmit the resource location from the second server to the first user device; and
a second server configured to generate a unique identifier, to transmit the identifier and a resource location for receipt by the first user device via the first server, to transmit the resource including a second executable component to the first user device, and to coordinate data communication between the first and second user device.

25. A system as claimed in claim 24, wherein the first user device is further configured to receive a first executable component and to execute the first component to request the identifier and the resource location via the first server.

26. A method as claimed in claim 25, wherein the first user device requests the first executable component using a location provided by the first server.

27. A method as claimed in claim 24, wherein the identifier and the resource location are received from the first server within a web-page.

28. A system as claimed in claim 24, wherein the connection is a two-way socket connection.

29. A system as claimed in claim 27, wherein the first user device is further configured to execute the first component to close the connection.

30. A system as claimed in claim 27, wherein the second server is further configured to map the identifier to the connection.

31. A system as claimed in claim 27, wherein the resource request includes the identifier.

32. A system as claimed in claim 26, wherein the second server is further configured to flag the identifier as in use when the request is received.

33. A system as claimed in claim 32, wherein the second server is further configured to deny requests when the identifier is flagged as in use.

34. A system as claimed in claim 27, wherein the second server is further configured to flag the identifier as claimed when the second user device claims the connection using the identifier.

35. A system as claimed in claim 34, wherein the second server is further configured to deny attempts to claim the connection when the identifier is flagged as claimed.

36. A system as claimed in claim 27, wherein the executable components are executed within a web-browser.

37. A system as claimed in claim 27, including a gateway server is configured to receive the request from the first server and selects the second server from a plurality of servers.

38. A system as claimed in claim 37, wherein the gateway server is further configured to select the second server based upon load-balancing.

39. A system as claimed in claim 37, wherein the second server is further configured to transmit the identifier and resource location to the first server via the gateway.

40. A system as claimed in claim 27, wherein the resource is a web-page.

41. A system as claimed in claim 27, wherein the second user device is further configured to generate a long-polling request of the second server.

42. A system as claimed in claim 41, wherein the second server is configured to communicate data relating to the first user device in response to the long-polling request.

43. (canceled)

44. (canceled)

45. (canceled)

46. A computer readable storage medium having stored therein a computer program executable on a user device, the computer program comprising:
code to receive an identifier and a resource location from a second server via a first server;
code to request a resource at the resource location;
code to receive a resource including a second executable component; and
code to execute the second component to create a connection between the user device and the second server.

47. (canceled)
